(19) United States
(12) Patent Application Publication
(10) Pub. No.: US 2014/0000231 A1
(43) Pub. Date: Jan. 2, 2014

(54) APPARATUS FOR CUTTING GRASS

(71) Applicant: Fabrizio BERNINI, Bucine (AR) (IT)

(72) Inventor: Fabrizio BERNINI, Bucine (AR) (IT)

(21) Appl. No.: 13/659,211

(22) Filed: Oct. 24, 2012

(30) Foreign Application Priority Data
Jun. 28, 2012 (EP) 12174175.5

(51) Int. Cl. A01D 69/02

(52) U.S. Cl. 56/11.9

(57) ABSTRACT

The invention discloses an apparatus for cutting grass comprising a lawn mower provided with first recharging means for recharging the lawn mower 1, and a recharging base comprising second recharging means removably in contact with the first recharging means, wherein the first recharging means and the second recharging means are fitted respectively to the lawn mower and to the recharging base in such a manner as to define a lateral reciprocal contact.

### CROSS-REFERENCE TO RELATED APPLICATION

This Application claims the benefit of priority from European Patent Application No. 12174175.5, filed Jun. 28, 2012, the contents of which are incorporated herein by reference.

### FIELD OF THE INVENTION

The present invention relates to an apparatus for cutting grass.

### BACKGROUND OF THE INVENTION

As is known, an automatic lawn mower manages the recharging step independently. One critical point of this step is the contact between the lawn mower and the recharging base, which determines the subsequent recharging operation.

As the automatic lawn mower manages the recharging step independently, no human intervention is envisaged to support this operation.

It follows that a good contact is established that constrains the lawn mower, to the appropriate extent, on the recharging base for the recharging operation.

On the other hand, the lawn mower must automatically seek the contact with the recharging base and this contact must also ensure easy release of the lawn mower at the end of the recharging operation, because also this operation is managed automatically by the lawn mower without any human intervention.

It must also be considered that technology is progressively increasing the capacity intensity and currents on recharging batteries.

This makes the need even more urgent to supply a recharge to the robot with a good contact to thus ensure high currents and thus avoid voltage leaks and/or drops.

In the light of what has been said, one object of the present invention is to provide an apparatus for improved cutting in terms of recharging efficiency.

Another object of the present invention is to provide an improved apparatus for cutting grass in terms of reliability during the recharging step.

### SUMMARY OF THE INVENTION

These and other objects are achieved by an apparatus for cutting grass, according to what has been disclosed in the attached claims 1 to 14.

The invention, as disclosed, achieves the following technical effects:
improved reliability of the lawn mower;
improved efficiency during the recharging step;
better exploitation of the recharging energy;
greater recharging speed; and
greater independence of the lawn mower.

The aforesaid technical effects and other technical effects of the invention will be disclosed in greater detail in the description, set out below, of an embodiment provided by way of non-limiting example with reference to the attached drawing.

### BRIEF DESCRIPTION OF THE DRAWINGS

FIG. 1 shows schematically a perspective view of the apparatus according to the invention;

FIG. 1a shows schematically a section view of FIG. 1;

FIG. 2 shows schematically details of components of FIGS. 1 and 1a;

FIG. 3 shows a unit comprised in the preceding figures in a first recharging state;

FIG. 4 shows the unit of FIG. 3 in a second recharging state; and

FIG. 5 shows a general cutting area in which the lawn mower of the invention operates.

### DETAILED DESCRIPTION OF THE INVENTION

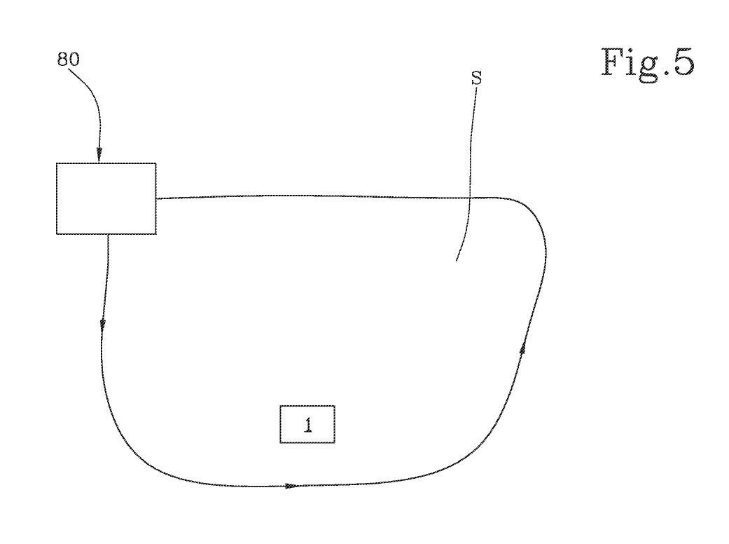

The invention discloses an apparatus for cutting grass comprising a lawn mower 1 provided with movement means 20 for moving the lawn mower 1 at least inside a cutting area S (FIG. 5).

The lawn mower 1 further comprises one or more blades 30 for cutting grass in the cutting area S.

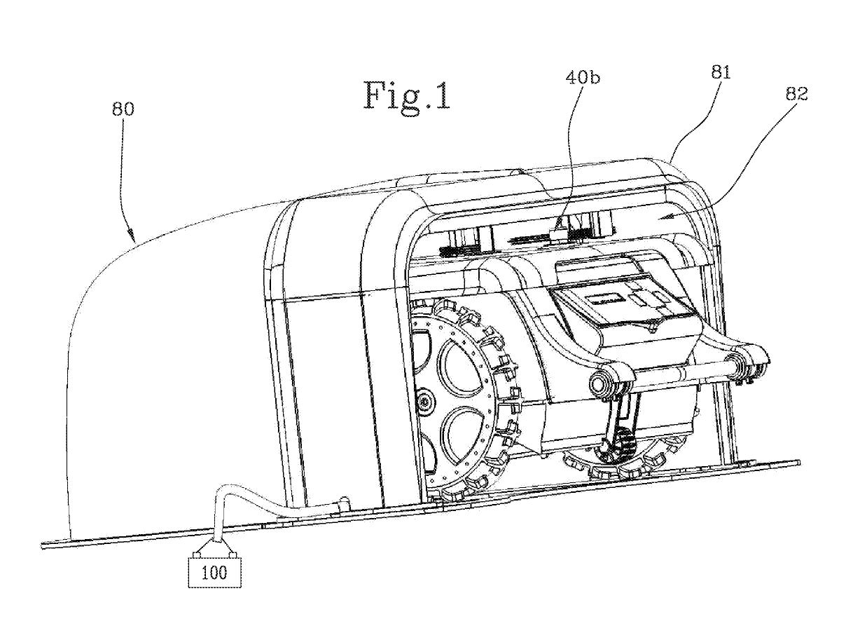

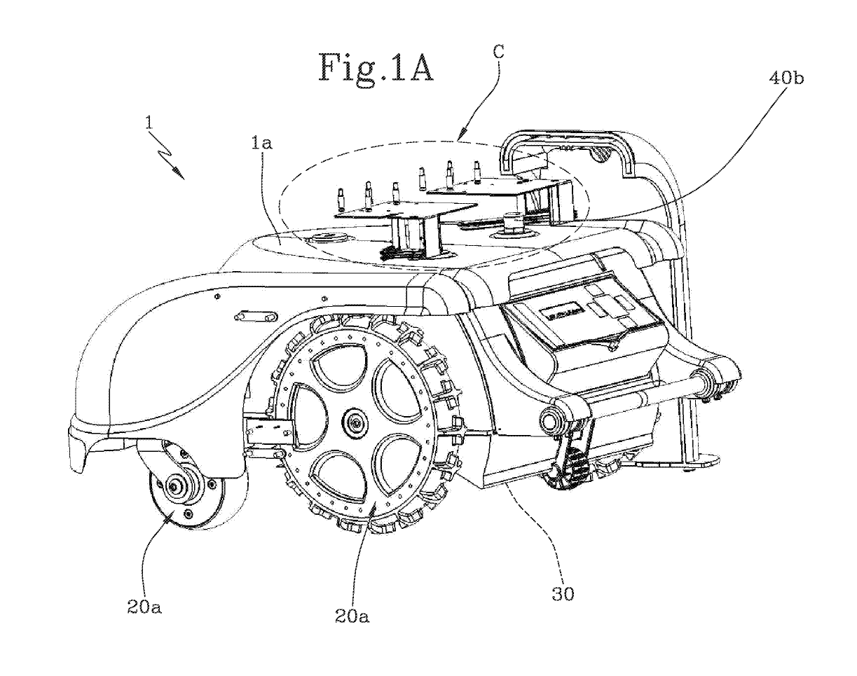

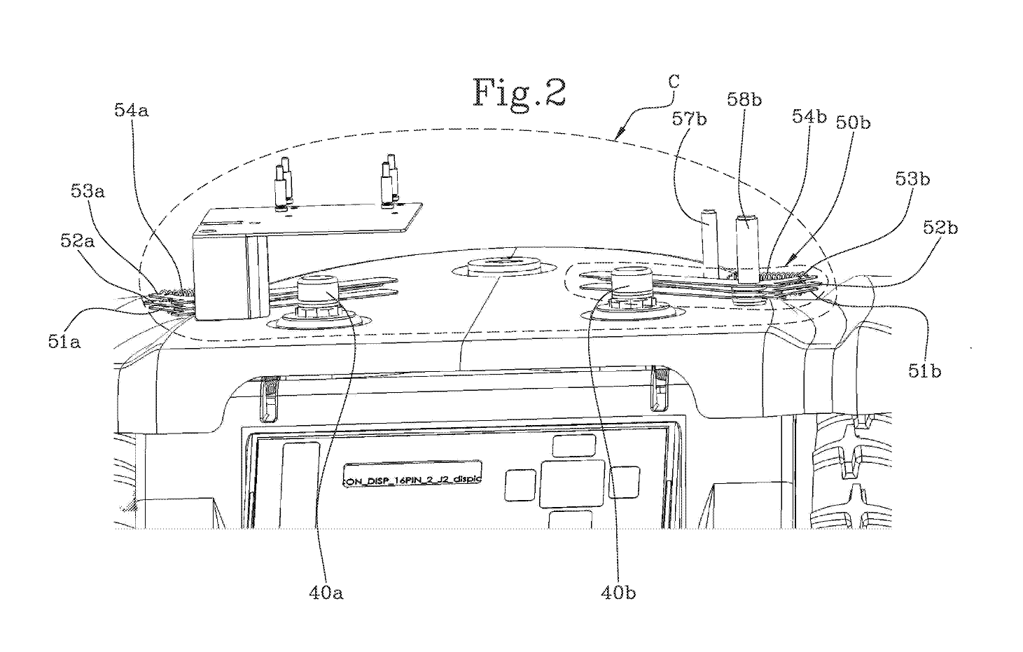

The lawn mower 1 further comprises first recharging means 40a, 40b, (FIGS. 1, 1a, 2) for recharging the lawn mower 1.

Such first recharging means 40a, 40b is fitted to a portion of the lawn mower 1 and protrudes therefrom.

Preferably, the first recharging means 40a, 40b, is fitted to an upper portion la of the lawn mower.

Preferably, the first recharging means 40a, 40b comprises knobs.

The apparatus for cutting grass of the invention comprises a recharging base 80 (FIG. 1) for the lawn mower 1.

The recharging base 80 comprises second recharging means 50a, 50b (FIGS. 2, 3, 4) that is removably in contact with the first recharging means 40a, 40b.

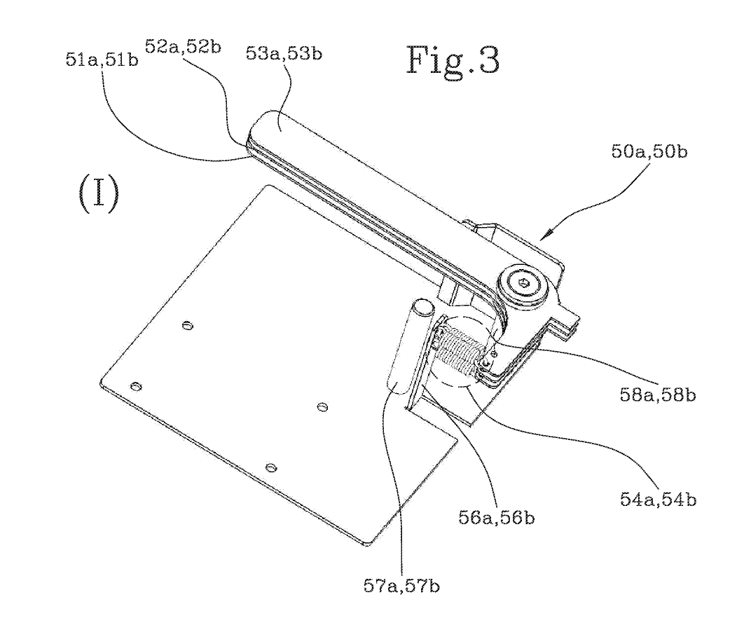

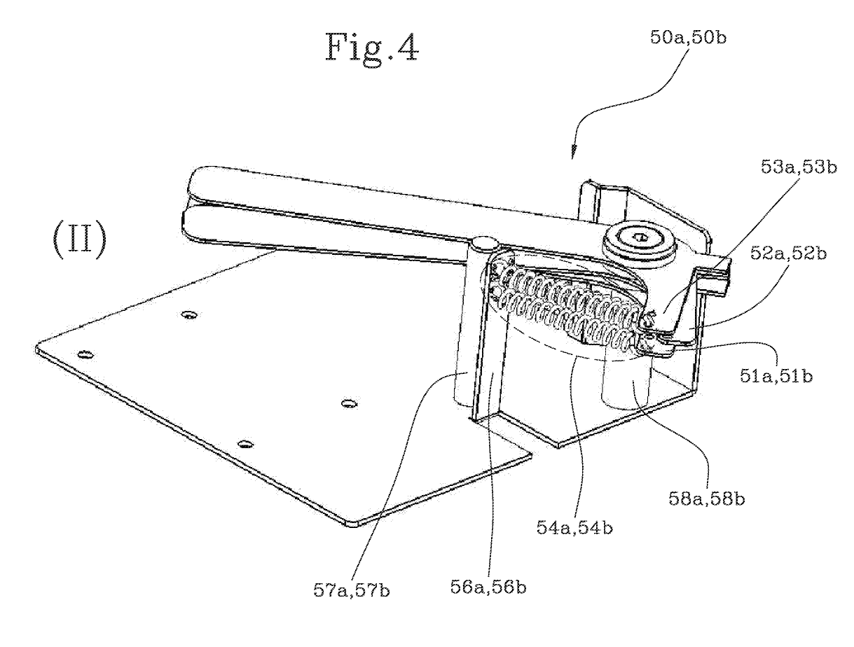

In particular, FIGS. 3 and 4 show, for ease of comprehension, the second recharging means 50a, 50b that is overturned compared with what is shown in FIG. 2.

Advantageously, according to the invention, the second recharging means 50a, 50b is fitted to the recharging base 80 in such a manner as to contact laterally the first recharging means 40a, 40b.

In other words, advantageously according to the invention, the first recharging means 40a, 40b is fitted to the lawn mower 1 in such a manner as to contact laterally the second recharging means 50a, 50b fitted to the recharging base 80.

More in general, the first recharging means 40a, 40b and the second recharging means 50a, 50b are fitted respectively to the lawn mower 1 and to the recharging base 80 in such a manner as to define a lateral reciprocal contact.

The recharging base 80 comprises a summit surface 81 and a recharging chamber 82 (FIG. 1).

Preferably, the second recharging means 50a, 50b is fitted to the recharging base 80 in such a manner as to protrude from the summit surface 81, extending towards the recharging chamber 82.

Advantageously, according to the invention, the second recharging means 50a, 50b comprises at least one blade 51a, 52a, 53a, 51b, 52b, 53b.

The technical effect achieved by this solution is that more lateral blades are defined between the first and the second recharging means that enables contact impedance to be reduced and thus the recharging current to be increased.

A further derived technical effect is that, owing to the increase in recharging current, it is thus possible to decrease recharging time and to increase the productivity of the lawn mower 1, thus guaranteeing cover of a greater cutting surface.

Further, the start of the next recharging cycle can be anticipated.

According to the invention, the second recharging means 50a, 50b comprises elastic means 54a, 54b (FIGS. 2, 3, 4) configured for maintaining at least one blade 51a, 52a, 53a, 51b, 52b, 53b in contact with the first recharging means 40a, 40b.

Preferably, the elastic means 54a, 54b comprises a spring 54a, 54b that is connected, at a first end thereof, to a staff 56a, 56b fixed to the summit surface 81 in such a manner as to constrain the first end of the spring.

Preferably, the elastic means 54a, 54b comprises the spring 54a, 54b connected, at a second end thereof, to at least one blade 51a, 52a, 53a, 51b, 52b, 53b, in such a manner that this at least one blade 51a, 52a, 53a, 51b, 52b, 53b is movably associated with the second end of the spring 54a, 54b.

At least one blade 51a, 52a, 53a, 51b, 52b, 53b is rotatably associated with a pivot 58a, 58b, protruding from the summit surface 81.

The intensity of the rotation of the blade depends on an extension variation on the spring 54a, 54b.

The recharging base further comprises a stroke end pivot 57a, 57b configured for limiting the stroke of the at least one blade 51a, 52a, 53a, 51b, 52b, 53b rotating around the pivot 58a, 58b.

The recharging base 80 further comprises a battery charger 100, such that each at least one blade 51a, 52a, 53a, 51b, 52b, 53b comprises a corresponding connection to the battery charger 100 itself. From the structure as described, advantageously, according to the invention, the first recharging means 40a, 40b and the second recharging means 50a, 50b define a recharging unit C (FIGS. 1a, 2) configured for operating between:
a first state I in which the first recharging means 40a, 40b and the second recharging means 50a,50b are disconnected, not determining any recharge (FIG. 3); and
a second state II in which the second recharging means 50a,50b contacts laterally the first recharging means 40a, 40b, determining a recharge of the lawn mower 1 (FIG. 4).

In other words, in the second state II, the first recharging means 40a, 40b contacts laterally the second recharging means 50a,50b.

More in general, in the second state II, the first recharging means 40a, 40b and the second recharging means 50a,50b are mounted respectively on the lawn mower 1 and on the recharging base 80 in such a manner as to define a lateral reciprocal contact.

With regard with what has been said so far, the apparatus of the invention has the following operation: the lawn mower 1 is configured for entering the recharging chamber 82 of the recharging base 80.

Further, the lawn mower is configured for pushing with the first recharging means 40a, 40b the second recharging means 50a, 50b in such a manner that the second recharging means 50a, 50b contacts laterally the first recharging means 40a, 40b, determining an operating change of the recharging unit C from the first recharging absence state I to the second lawn mower recharging state II.

In other words, the lawn mower 1 is configured for pushing with the first recharging means 40a, 40b the second recharging means 50a, 50b in such a manner that the first recharging means 40a, 40b contacts laterally the second recharging means 50a, 50b, determining an operating change of the recharging unit C from the first recharging absence state I to the second lawn mower 1 recharging state II.

More in general, the lawn mower is configured for pushing with the first recharging means 40a, 40b the second recharging means 50a, 50b in such a manner that the first recharging means 40a, 40b and the second recharging means 50a, 50b define a lateral reciprocal contact determining an operating change of the recharging unit C from the first recharging absence state Ito the second lawn mower 1 recharging state II.

The thrust with the first recharging means 40a, 40b on the second recharging means 50a, 50b occurs in such a manner that the second recharging means 50a, 50b contacts laterally the first recharging means 40a, 40b or, in other words, the first recharging means 40a, 40b contacts laterally the second recharging means 50a, 50b.

More in general, the thrust with the first recharging means 40a, 40b on the second recharging means 50a, 50b occurs in such a manner that the first recharging means 40a, 40b and the second recharging means 50a, 50b define a lateral reciprocal contact.

This thrust determines a pressure of the elastic means 54a, 54b on the at least one blade 51a, 52a, 53a, 51b, 52b, 53b in such a manner as to maintain the blade 51a, 52a, 53a, 51b, 52b, 53b in contact with the first recharging means.

The invention, as disclosed, achieves the following technical effects:
improved reliability of the lawn mower;
improved efficiency during the recharging step;
better exploitation of the recharging energy;
greater recharging speed; and
greater range of the lawn mower.

1. Apparatus for cutting grass comprising:
a lawn mower provided with:
movement means for moving said lawn mower at least inside one cutting area (S);
one or more blades for cutting grass in said cutting area (S); and
first recharging means, for recharging said lawn mower, fitted to a portion of said lawn mower and protruding therefrom; and
a recharging base, for said lawn mower, comprising second recharging means removably in contact with said first recharging means,
wherein said second recharging means is fitted to said recharging base in such a manner as to define a lateral reciprocal contact with said first recharging means;
said first and second recharging means defining a recharging unit (C) configured for operating between:
a first state (I) wherein said first and second recharging means is disconnected, not determining any recharge; and
a second state (II) wherein said first recharging means and said second recharging means define a lateral reciprocal contact determining a recharge of said lawn mower.

2. Apparatus according to claim 1, wherein said second recharging means is fitted to said recharging base in such a manner as to contact laterally said first recharging means, and in said second state (II) said second recharging means contacts laterally said first recharging means, determining a recharge of said lawn mower.

3. Apparatus according to claim 1, wherein said first recharging means is fitted to an upper portion of said lawn mower and protruding therefrom.

4. Apparatus according to claim 1, wherein said recharging base comprises a summit surface and a recharging chamber and said second recharging means is fitted to said recharging base in such a manner as to protrude from said summit surface extending towards said recharging chamber.

5. Apparatus according to claim 1, wherein said second recharging means comprises at least one blade.

6. Apparatus according to claim 5, wherein said second recharging means comprises elastic means configured for maintaining said at least one blade in contact with said first recharging means.

7. Apparatus according to claim 6, wherein said elastic means comprises a spring connected, at a first end thereof, to a bracket fixed to said summit surface in such a manner as to constrain said end of said spring.

8. Apparatus according to claim 6, wherein said elastic means comprises a spring connected, at a second end thereof to said at least one blade, said at least one blade being movably associated with said spring.

9. Apparatus according to claim 5, wherein said at least one blade is rotatably associated with a pivot, protruding from said summit surface, as a function of an extension variation of said spring.

10. Apparatus according to claim 5, comprising a stroke end pivot configured for limiting the stroke of said at least one blade rotating around said pivot.

11. Apparatus according to claim 4, wherein said lawn mower is configured for:
entering said recharging chamber of said recharging base; and
pushing with said first recharging means in such a manner that the first recharging means and the second recharging means define a lateral reciprocal contact, determining an operating change of said recharging unit (C) from said first recharging absence state (I) to said second lawn mower recharging state (II).

12. Apparatus according to claim 11, wherein said first recharging means is configured for pushing on said second recharging means in such a manner that the first recharging means and the second recharging means define a lateral reciprocal contact determining a pressure of said elastic means on said at least one blade in such a manner as to maintain the blade in contact with said first recharging means.

13. Apparatus according to claim 1, wherein said recharging base comprises a battery charger, and wherein each said at least one blade comprises a corresponding connection to said battery charger.

14. Apparatus according to claim 1, wherein said first recharging means comprises knobs.
